(19) United States
(12) Patent Application Publication
(10) Pub. No.: US 2020/0306676 A1
(43) Pub. Date: Oct. 1, 2020

(54) METHOD FOR PRODUCING HONEYCOMB STRUCTURE

(71) Applicant: NGK INSULATORS, LTD., Nagoya-Shi (JP)

(72) Inventors: Masaki NISHIOKA, Nagoya-Shi (JP); Ken ITADU, Nagoya-Shi (JP); Jun INOUE, Nagoya-Shi (JP); Yoshitaka TABUCHI, Nagoya-Shi (JP); Michio SUZUKI, Nagoya-Shi (JP); Daiki NANYA, Nagoya-Shi (JP)

(73) Assignee: NGK INSULATORS, LTD., Nagoya-Shi (JP)

(21) Appl. No.: 16/816,746

(22) Filed: Mar. 12, 2020

(30) Foreign Application Priority Data
Mar. 27, 2019 (JP) 2019-061757

(51) Int. Cl. B01D 46/00; B01D 46/24; B28B 3/20; B28B 11/24; B28B 11/08; C04B 38/00

(52) U.S. Cl. CPC B01D 46/0001; B01D 46/2474; B28B 3/20; B28B 11/243; B28B 2003/203; C04B 38/0009; C04B 38/0019; B01D 2279/30; B01D 2046/2481; B28B 11/08

(57) ABSTRACT

A method for producing a honeycomb structure for fine particle collection filters. The honeycomb structure includes a plurality of porous honeycomb segments joined together via joining material layers. The method includes the steps of: forming the outer peripheral wall of each of the porous honeycomb segments so as to have a thickness thicker by a grinding margin; drying the porous honeycomb segments each formed by grinding the outer peripheral wall so as to have the thickness thicker by the grinding margin; firing the dried porous honeycomb segments; grinding and removing the grinding margin of the outer peripheral wall of each of the fired porous honeycomb segments; and applying a joining material to each of the porous honeycomb segments with the grinding margin ground and removed, between joining surfaces of each of the porous honeycomb segments, to join the porous honeycomb segments via the joining material layers.

### FIELD OF THE INVENTION

The present invention relates to a method for producing a honeycomb structure. More particularly, the present invention relates to a method for producing a honeycomb structure, which can produce a honeycomb structure having good thermal shock resistance with good production efficiency.

### BACKGROUND OF THE INVENTION

Conventionally, an internal combustion engine incorporates a diesel particulate filter (DPF) to collect fine particles contained in an exhaust gas from a diesel engine. Further, the internal combustion engine may incorporate a gasoline particulate filter (GPF) to collect fine particles contained in an exhaust gas from a gasoline engine. The DPF and GPF are formed by joining a plurality of porous honeycomb segments such as silicon carbide (SIC) through a joining material, and have a structure obtained by grinding an outer periphery of a segment joined body having the joined honeycomb segments to form a honeycomb structure having an appropriate shape such as a circle and an ellipse, and then coating the outer peripheral surface with a coating material.

Patent Literature 1 discloses a method for producing a honeycomb structure by joining a plurality of porous honeycomb segments through an adhesive material to produce a segment joined body. In the method for producing the honeycomb structure as described in Patent Literature 1, as shown in FIG. 1, a plurality of porous honeycomb segments 10 are stacked along an L-shaped receiving plate 30 via adhesive layers 20 to obtain a desirable stacked structure, and then applying a pressure onto the entire structure. This leads to production of a segment joined body (honeycomb structure 40) in which the porous honeycomb segments 10 are vertically and horizontally stacked.

### CITATION LIST

### Patent Literature

Patent Literature 1: Japanese Patent Application Publication No. 2004-262670 A

### SUMMARY OF THE INVENTION

In the production of the joined body of the porous honeycomb segments 10 as shown in FIG. 1, if the plurality of honeycomb segments 10 have variations in the outer shapes, the width of the adhesive layer 20 used for joining may vary as shown in FIG. 2. Further, as shown in FIG. 3, the arrangement of the adjacent honeycomb segments 10 may be shifted. Such a variation in the width of the adhesive layer 20 and shift of the arrangement of the honeycomb segments 10 are one of causes of a change in heat transfer, and may cause a problem that thermal shock resistance which is a characteristic of the DPF or GPF made of the SiC material is decreased.

Further, since the variation in the outer shapes of the honeycomb segments 10 is mainly caused by shrinkage in the firing step of the honeycomb segments 10, there is a problem of having to be addressed by decreasing the production efficiency, such as increasing a firing time, in order to improve the variation in the outer shapes of the honeycomb segments 10.

An object of the present invention is to provide a method for producing a honeycomb structure having good thermal shock resistance with good production efficiency.

As a result of intensive studies, the present inventors have found that the above problems can be solved by previously forming the outer peripheral walls of the individual porous honeycomb segments to be thicker by grinding margins, and drying and firing them, and then stacking those obtained by grinding and removing the grinding margins and joining them. Thus, the present invention is specified as follows:

A method for producing a honeycomb structure for fine particle collection filters, the honeycomb structure comprising a plurality of porous honeycomb segments joined together via joining material layers, each of the porous honeycomb segment comprising: partition walls made of a SiC material, the partition walls defining a plurality of cells to form flow paths for a fluid, each of the cells extending from an inflow end face that is an end face on a fluid inflow side to a fluid outflow end face that is an end face on a fluid inflow side; and an outer peripheral wall located at the outermost periphery, the method comprising the steps of:

forming the outer peripheral wall of each of the porous honeycomb segments so as to have a thickness thicker by a grinding margin;

drying the porous honeycomb segments each formed by grinding the outer peripheral wall so as to have the thickness thicker by the grinding margin; firing the dried porous honeycomb segments;

grinding and removing the grinding margin of the outer peripheral wall of each of the fired porous honeycomb segments; and

applying a joining material to each of the porous honeycomb segments with the grinding margin ground and removed, between joining surfaces of each of the porous honeycomb segments, to join the porous honeycomb segments via the joining material layers.

According to the present invention, it is possible to provide a method for producing a honeycomb structure having good thermal shock resistance with good production efficiency.

### BRIEF DESCRIPTION OF THE DRAWINGS

FIG. 1 is a schematic view showing a conventional honeycomb segment and a manner of producing a segment joined body by joining the honeycomb segments.

FIG. 2 is an appearance observation photograph showing a variation in a width of an adhesive layer in a conventional segment joined body.

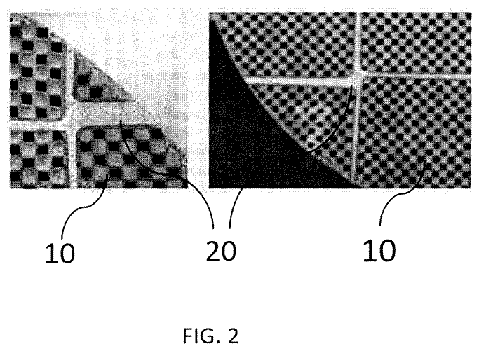

FIG. 3 is an appearance observation photograph showing arrangement shift for honeycomb segments in a conventional segment joined body.

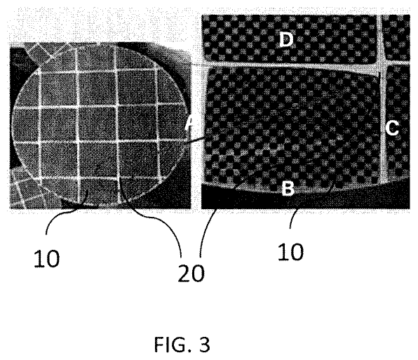

FIG. 4 is a schematic external view of a honeycomb structure according to an embodiment of the present invention.

FIG. 5 is a schematic external view of a porous honeycomb segment according to an embodiment of the present invention, in which an outer peripheral wall is formed to be thicker by a grinding margin.

FIG. 6 is a schematic external view of a porous honeycomb segment according to an embodiment of the present invention, in which a grinding margin has been ground and removed.

FIG. 7 is a schematic external view of a grinding jig in which a disk-shaped grindstone is provided at a tip of a rotation axis.

FIGS. 8A and 8B are schematic views showing a measurement position of a distance L in a porous honeycomb segment according to each of Example and Comparative Example.

### DETAILED DESCRIPTION OF THE INVENTION

Hereinafter, embodiments of a method for producing a honeycomb structure according to the present invention will be specifically described with reference to the drawings. It is to understand that the present invention is not limited to the following embodiments, and various design modifications and improvements may be made based on ordinary knowledge of a person skilled in the art, without departing from the scope of the present invention.

(Method for Producing Honeycomb Structure)

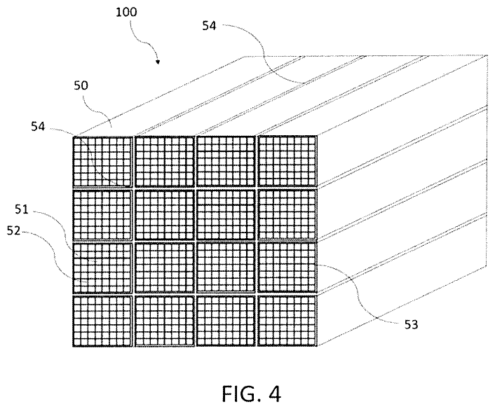

FIG. 4 is a schematic external view of a honeycomb structure 100 produced by a method for producing a honeycomb structure according to an embodiment of the present invention. The honeycomb structure 100 is formed by binding a plurality of porous honeycomb structure segments 50 together via joining material layers 54, in which each porous honeycomb structure segment 50 includes: partition walls 52 made of a SiC material, which define a plurality of cells 51 to form flow paths for a fluid, and which extend from an inflow end face that is an end face on a fluid inflow side to an outflow end face that is an end face on a fluid outflow side; and an outer peripheral wall 53 located at the outermost periphery. Here, the SiC material means a material mainly based on SiC (silicon carbide), including, for example, a material consisting only of SiC such as recrystallized SiC, Si-SiC based composite materials, cordierite-SiC based composite materials, metal silicon-impregnated SiC, and the like.

The honeycomb structure 100 is formed by grinding the outer periphery into an appropriate shape such as a circular shape and an elliptical shape, and then coating the outer peripheral surface with a coating material, and is used as a fine particle collection filter such as a diesel engine particulate filter (DPF) and a gasoline particulate filter (GPF). The inflow end face or the outflow end face of the cells 51 serving as the flow paths for the fluid in the honeycomb structure 100 are provided with plugged portions, whereby fine particles (such as carbon fine particles) in an exhaust gas can be collected. Although the plugged portions may be provided at any time, but it is more preferable to provide the plugged portions before firing the porous honeycomb segments 50, because the plugged portions and the partition walls 52 are sintered by the firing.

For the honeycomb structure 100, a catalyst may be further provided on surfaces or inner side of the partition walls 52 made of a SiC material that define the plurality of cells 51. A type of the catalyst is not particularly limited, and it can be appropriately selected according to the use purpose and application of the honeycomb structure 100. Examples of the catalyst include noble metal catalysts or catalysts other than them. Illustrative examples of the noble metal catalysts include a three-way catalyst and an oxidation catalyst obtained by supporting a noble metal such as platinum (Pt), palladium (Pd) and rhodium (Rh) on surfaces of pores of alumina and containing a co-catalyst such as ceria and zirconia, or a lean nitrogen oxides trap catalyst (LNT catalyst) containing an alkaline earth metal and platinum as storage components for nitrogen oxides (NOₓ). Illustrative examples of a catalyst that does not use the noble metal include a NOx selective catalytic reduction catalyst (SCR catalyst) containing a copper-substituted or iron-substituted zeolite, and the like. Further, two or more catalysts selected from the group consisting of those catalysts may be used. A method for supporting the catalyst is not particularly limited, and it can be carried out according to a conventional method for supporting the catalyst on the honeycomb structure 100.

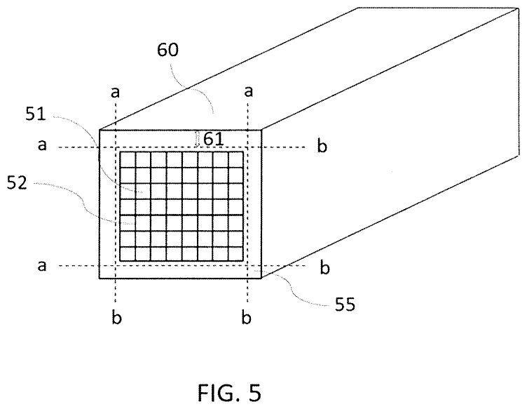

In the method for producing the honeycomb structure according to an embodiment of the present invention, first, the porous honeycomb segments 60 as illustrated in FIG. 5 are produced. The outer peripheral wall 55 of each of the porous honeycomb segments 60 is formed so as to have a thickness thicker by a grinding margin 61.

As the production step of the porous honeycomb segments 60, first, a binder, a dispersant (surfactant), a pore former, water, and the like are added to a ceramic raw material made of a SiC material, and these are mixed and kneaded to prepare a green body. The prepared green body is then formed into a honeycomb shape by an extrusion molding method to obtain a raw (unfired) pillar shaped honeycomb formed body. The pillar shaped honeycomb formed body extruded from an extruder is cut into an appropriate length. The extrusion molding method can be carried out using an apparatus such as a ram type extruder and a bi-axial screw type continuous extruder. For forming the honeycomb shape, a method using a die having a desired cell shape, partition wall thickness, and cell density is preferable. Thus, the porous honeycomb segment 60 which is the unfired honeycomb formed body having the outer peripheral wall 55 formed to be thicker by the grinding margin 61 is produced.

The porous honeycomb segment 60 which is the unfired honeycomb formed body having the outer peripheral wall 55 formed to be thicker by the grinding margin 61 may be produced by extrusion molding as described above, or may be produced by forming the pillar shaped honeycomb formed body by extrusion molding and then forming the outer peripheral wall 55 to be thicker by the grinding margin 61.

An outer shape of each porous honeycomb segment 60 is not particularly limited, and it may be a pillar shape with rectangular end faces as in the present embodiment, or a pillar shape with circular end faces (circular pillar shape), or a pillar shape with polygonal (triangular, pentagonal, hexagonal, heptagonal, octagonal, etc.) end faces, except for rectangular end faces.

The porous honeycomb segments 60 each having the outer peripheral wall 55 formed to be thicker by the grinding margin 61 are then dried. The drying may be carried out by dielectric drying using high-frequency energy generated by passing a current through the porous honeycomb segments 60, or may be carried out by hot air drying which introduces hot air into the porous honeycomb segments 60. Further, natural drying left at room temperature, microwave drying using a microwave, freeze drying, or the like may be carried out, or a combination of a plurality of drying methods may be carried out. Subsequently, the porous honeycomb segments 60 are fired.

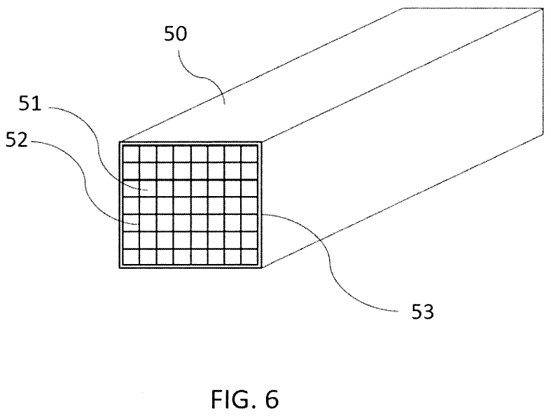

For the porous honeycomb segments 60 after firing, the grinding margin 61 formed on each of four side surfaces of the outer peripheral wall 55 are ground and removed, for example along straight lines indicated by dotted lines a-b, as shown in FIG. 5. The grinding margin 118 is thus removed to produce the porous honeycomb segments 50 as shown in FIG. 6.

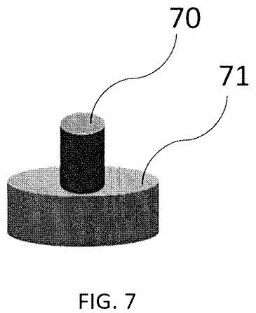

The grinding margin 61 can be ground and removed using a grinding jig. For example, as shown in FIG. 7, a grinding jig having a structure in which a disk-shaped grindstone 71 is provided at a tip of a rotation axis 70 can be used. According to the grinding jig, the grinding margins 61 each formed on the four side surfaces of the outer peripheral wall 55 of the fired porous honeycomb segment 60 can be gradually ground and removed by bringing the grindstone 71 into contact with the grinding margins 61 while rotating the grindstone 71 at a high speed by a rotation drive from the rotation axis 70.

The grindstone 71 preferably has a count in a range of from #80 to #120. By carrying out the grinding of the outer peripheral wall 55 using the grindstone 71 having a count in a range of from #80 to #120, the surface roughness of the outer peripheral wall 53 after grinding and removing the grinding margin 61 is decreased, and leads to ease of uniform processing. Therefore, in the joining step of the plurality of porous honeycomb segments as described later, the plurality of porous honeycomb segments having smaller variations in the outer shapes can be joined.

When the grinding margin 61 of the outer peripheral wall 55 of the porous honeycomb segment 60 is ground and removed, it is preferable to further include a step of grinding and removing the grinding margin 61 of the outer peripheral wall 55 of a part of the porous honeycomb segment 60, and then rotating the porous honeycomb segment 60 in a direction parallel to a direction connecting the inflow end face to the outflow end face as a direction of the rotation axis to grind and remove the grinding margin of the outer peripheral wall 55 of the other part of the porous honeycomb segment 60. More particularly, the grinding margin 61 is preferably ground and removed by fixing porous honeycomb segment 60 such that the segment side surface parallel to the direction connecting the inflow end face to the outflow end face is parallel to a plane portion of the rotating grindstone, and bringing the grindstone 71 into contact with the porous honeycomb segment for only a fraction of the grinding margin 61. Further, the porous honeycomb segment 60 is preferably ground by rotating it at a specified angle. For example, if the porous honeycomb segment 60 is a rectangular parallelepiped segment, the grinding margin may be ground by rotating the porous honeycomb segment 60 at 90 degrees at the end of the grinding of an upper surface of the porous honeycomb segment 60 using a machining center for grinding the four side surfaces, and placing the porous honeycomb segment 60 such that an unprocessed surface is the upper surface. With such a configuration, the movement of the grinding jig becomes efficient, for example when the length of the porous honeycomb segment 60 in the cell extending direction is longer, so that the grinding efficiency is improved.

A thickness of the grinding margin 61 of the porous honeycomb segment 60 after firing is preferably from 20 to 80% of the thickness of the outer peripheral wall 55 before the grinding margin 61 is ground and removed. If the thickness of the grinding margin 61 is less than 20% of the thickness of the outer peripheral wall 55 before the grinding margin 61 is ground and removed, the deformation volume of the segment outer shape generated during the firing cannot be absorbed, causing a problem that the outer shape of the segment cannot be uniform. Further, if the thickness of the grinding margin 61 is more than 80% of the thickness of the outer peripheral wall 55 before the grinding margin 61 is ground and removed and the grinding exceeds the thickness of the outer peripheral wall 55, a collecting portion of the filter may be ground to unify the interiors of the cells, causing a problem that a product function (filter performance) is reduced. The thickness of the grinding margin 61 of the porous honeycomb segment 60 after firing is more preferably from 30 to 70%, and even more preferably from 40 to 60% of the thickness of the outer peripheral wall 55 before the grinding margin 61 is ground and removed. Although the optimum value of the thickness of the grinding margin 61 varies depending on the structure of the porous honeycomb segment 50, a longer length in the cell extending direction tends to increase deformation of the shape during the firing. Therefore, it is preferable to increase the thickness of the grinding margin 61.

In the grinding of the grinding margin 61 of the porous honeycomb segment 60, it is preferable to perform the grinding so that the outer shape of the plurality of ground porous honeycomb segment 50 becomes uniform. The uniform outer shapes of the plurality of ground porous honeycomb segments 50 can lead to uniformness of the thicknesses of the joining layers when joining the porous honeycomb segments 50.

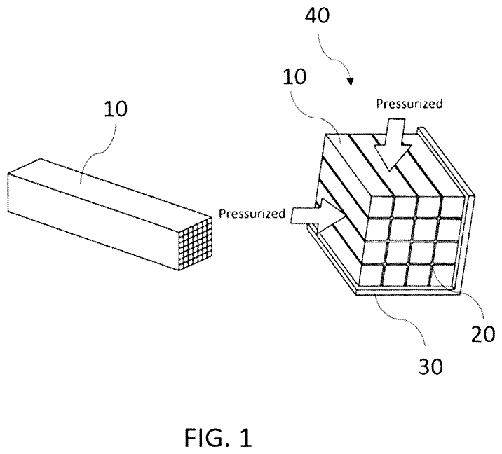

The joining material is then applied to each of the plurality of porous honeycomb segments 50 with the grinding margin ground and removed, between the joining surfaces to join them via the joining material layers 54. In the joining step, a plurality of porous honeycomb segments 50 may be stacked along an L-shaped receiving plate via the joining material layers 54 using the method shown in FIG. 1 to form a desired stacked structure, and then applying a pressure to the entire structure to join them. Thus, the honeycomb structure 100 as shown in FIG. 4 is produced.

In the joining step, since each porous honeycomb segment 50 has ground and removed the grinding margin 61 as described above, the outer walls 53 of the respective porous honeycomb segments 50 have uniform surface properties, so that a variation in the outer shapes of the honeycomb segments 50 are suppressed. Therefore, in the honeycomb structure 100 formed by joining the plurality of porous honeycomb segments 50, the variation in the widths of the joining material layers 54 used for joining is suppressed, and the arrangement shift of the adjacent porous honeycomb segments 50 is suppressed. Therefore, the honeycomb structure 100 has constant thermal transmission, and suppresses a problem that the thermal shock resistance which is a characteristic of the particulate filter made of the SiC material such as DPF or GPF is reduced. Further, a problem of having to be addressed by decreasing a production efficiency in order to improve the variation in the outer shapes of the honeycomb segments as in the prior arts is eliminated, so that the production efficiency of the honeycomb structure 100 is improved.

The joining material forming the joining material layers 54 is not particularly limited as long as it can join the surfaces of the outer peripheral walls 53 made of the SiC material to each other with good adhesive strength. The joining material forming the joining material layers 54 may contain, for example, inorganic particles, and inorganic fibers and colloidal oxides as other components. Further, during the joining of the porous honeycomb segments 50, in addition to those components, an organic binder such as methylcellulose and carboxymethylcellulose, a dispersant, water and the like may be optionally added, and mixed and kneaded using a kneader such as a mixer to form a paste, which may be used as a joining material.

Examples of materials for forming the inorganic particles contained in the joining material forming the joining material layers 54 includes ceramics selected from the group consisting of silicon carbide, silicon nitride, cordierite, alumina, mullite, zirconia, zirconium phosphate, aluminum titanate, titania, and combinations thereof; Fe-Cr-Al-based metals; nickel-based metals; silicon-silicon carbide-based composite materials; and the like.

Examples of the inorganic fibers contained in the joining material forming the joining material layers 54 include ceramic fibers such as aluminosilicate and silicon carbide, and metal fibers such as copper and iron. Suitable colloidal oxides include silica sol, alumina sol and the like. The colloidal oxides are suitable for providing a suitable adhesive force to the joining material, and can also be bonded to the inorganic fibers and the inorganic particles by drying and degreasing them to provide a strong joining material having improved heat resistance after drying.

### EXAMPLES

Hereinafter, examples will be provided for better understanding of the present invention and its advantages, but the present invention is not limited to these examples.

### Example 1

As Example 1, a raw (unfired) porous honeycomb segment having an outer peripheral wall thicker by a grinding margin as shown in FIG. 5 was produced by extruding a green body made of a SiC material.

The raw (unfired) porous honeycomb segment having the outer peripheral wall thicker by the grinding margin was then dried, and then provided with plugged portions and fired. The porous honeycomb segment after the firing was in a rectangular parallelepiped shape, and had a thickness of the outer peripheral wall of 1.8 mm and a thickness of the grinding margin of 1.3 mm. The thicknesses of the outer peripheral wall was measured using a microscope (Dino-Lite Premium from by ANMO Electronics Corporation) at 20 positions per one side surface (20 positions×80 positions on four side surfaces, because the porous honeycomb segment of Example 1 was in a rectangular parallelepiped shape) of the outer peripheral wall on one end face of one segment, and an average value thereof was calculated. The length of the fired porous honeycomb segment in the cell extending direction was 203.7 mm.

The grinding margin of the fired porous honeycomb segment was then ground and removed with a grinding jig having a grindstone with a count of #120. In this case, after grinding and removing one side surface of the fired porous honeycomb segment, the porous honeycomb segment was rotated by 90 degrees to arrange it such that the unprocessed surface faced the grindstone side, and ground in the same manner. Thus, the porous honeycomb segment was rotated, and all of the four side surfaces were ground.

### Comparative Example 1

As Comparative Example 1, a raw (unfired) porous honeycomb segment was produced using a green body made of the same SiC material as that of Example 1 by extruding the green body. In Comparative Example 1, the raw porous honeycomb segment having a conventional shape was formed without providing a grinding margin on the outer peripheral wall as in Example 1. The raw porous honeycomb segment was then dried under the same conditions as those of Example 1, and then provided with plugged portions and fired. The fired porous honeycomb segment was in a rectangular parallelepiped shape, and had a thickness of the outer peripheral wall of 0.5 mm. The length of the fired porous honeycomb segment in the cell extending direction was 203.7 mm.

(Evaluation)

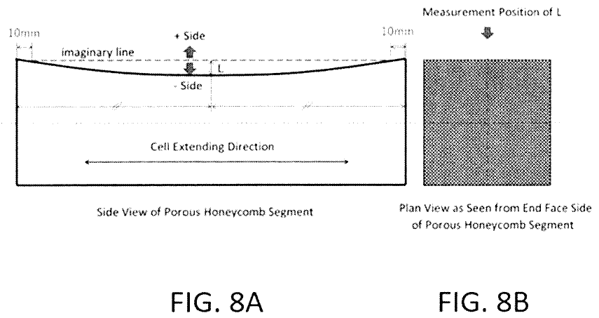

Next, as shown in FIG. 8A, for each of the rectangular parallelepiped porous honeycomb segments according to Example 1 and Comparative Example 1, a distance L at a central point in the cell extending direction was measured with respect to a straight line (imaginary line) connecting points positioned inwardly 100 mm from both ends in the cell extending direction. As shown in FIG. 8B, the measurement position of the distance L as viewed from the end face side of the cell was a central point on one side of a plane perpendicular to the cell extending direction.

The measurement was carried out on four side surfaces of one segment for each of the rectangular parallelepiped honeycomb segments according to Example 1 and Comparative Example 1, and the largest measured value (absolute value) among them was defined as a distance Lₘₐₓ.

As a result, in the porous honeycomb segment according to Comparative Example 1, the distance Lₘₐₓ was −0.8 mm, whereas in the porous honeycomb segment according to Example 1, the distance Lₘₐₓ was −0.05 mm, indicating that shape defects were suppressed.

### DESCRIPTION OF REFERENCE NUMERALS

10, 50, 60 porous honeycomb segment

20 adhesive layer

30 receiving plate

40, 100 honeycomb structure

51 cell

52 partition wall

53, 55 outer peripheral wall

54 joining material layer

61 grinding margin

70 rotation axis

71 grindstone

What is claimed is:

1. A method for producing a honeycomb structure for fine particle collection filters, the honeycomb structure comprising a plurality of porous honeycomb segments joined together via joining material layers, each of the porous honeycomb segment comprising: partition walls made of a SiC material, the partition walls defining a plurality of cells to form flow paths for a fluid, each of the cells extending from an inflow end face that is an end face on a fluid inflow side to a fluid outflow end face that is an end face on a fluid inflow side; and an outer peripheral wall located at the outermost periphery, the method comprising the steps of:
forming the outer peripheral wall of each of the porous honeycomb segments so as to have a thickness thicker by a grinding margin;
drying the porous honeycomb segments each formed by grinding the outer peripheral wall so as to have the thickness thicker by the grinding margin;
firing the dried porous honeycomb segments;
grinding and removing the grinding margin of the outer peripheral wall of each of the fired porous honeycomb segments; and
applying a joining material to each of the porous honeycomb segments with the grinding margin ground and removed, between joining surfaces of each of the porous honeycomb segments, to join the porous honeycomb segments via the joining material layers.

2. The method for producing the honeycomb structure according to claim 1, wherein a thickness of the grinding margin is from 20 to 80% of that of the outer peripheral wall before the grinding margin is ground and removed.

3. The method for producing the honeycomb structure according to claim 1, wherein in the step of forming the outer peripheral wall of each of the porous honeycomb segments so as to have the thickness thicker by the grinding margin, a green body made of a SiC material is extruded to produce the outer peripheral wall so as to have the thickness thicker by the grinding margin, and the firing is then carried out.

4. The method for producing the honeycomb structure according to claim 1, wherein the step of grinding and removing the grinding margin of the outer peripheral wall of each of the fired porous honeycomb segments further comprises a step of grinding and removing the grinding margin of the outer peripheral wall of a part of each of the porous honeycomb segments, and then rotating each of the porous honeycomb segments in a direction parallel to a direction connecting the inflow end face to the outflow end face as a direction of an rotation axis to grind and remove the grinding margin of the outer peripheral wall of the other part of each of the porous honeycomb segments.

5. The method for producing the honeycomb structure according to claim 1, wherein in the step of grinding and removing the grinding margin of the outer peripheral wall of each of the porous honeycomb segments, the grinding margin is ground and removed using a grindstone having a count of from #80 to #120.
